(19) United States
(12) Patent Application Publication
(10) Pub. No.: US 2023/0018438 A1
(43) Pub. Date: Jan. 19, 2023

(54) HYBRID STATOR CORE SEGMENTS FOR AXIAL FLUX MOTORS

(71) Applicant: GM GLOBAL TECHNOLOGY OPERATIONS LLC, Detroit, MI (US)

(72) Inventors: Jian Yao, Shanghai (CN); Chengwu Duan, Shanghai (CN)

(21) Appl. No.: 17/563,338

(22) Filed: Dec. 28, 2021

(30) Foreign Application Priority Data
Jul. 16, 2021 (CN) 202110807543.4

(51) Int. Cl. H02K 1/16; H02K 3/12; H02K 7/00

(52) U.S. Cl. CPC H02K 1/16; H02K 3/12; H02K 7/003

(57) ABSTRACT

An axial flux motor is provided and includes a shaft, at least one rotor connected to the shaft, and a stator. The stator includes a stator core and an electrically conductive wire. The stator core is segmented and ring-shaped and includes a central opening through which the shaft extends to the at least one rotor. The stator core includes a hybrid segment. The hybrid segment includes soft magnetic composite material components and laminated layered blocks. The laminated layered blocks include two inclined laminated layered blocks, where a distance between the two inclined laminated layered blocks increases radially along a radially extending centerline of the hybrid segment. The electrically conductive wire wound on the hybrid segment.

### CROSS-REFERENCE TO RELATED APPLICATIONS

This application claims the benefit of Chinese Patent Application No.

202110807543.4, filed on Jul. 16, 2021. The entire disclosure of the application referenced above is incorporated herein by reference.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates to stators of axial flux motors, and more specifically to segments of stator cores in axial flux motors.

Electric motors convert electrical energy into mechanical work by the production of torque, while electric generators convert mechanical work to electrical energy. Electric vehicles and hybrid vehicles employ electric motors/generators, such as induction and permanent magnet motors/generators for propulsion and to capture braking energy. Although motors are primarily referred to herein, the principles described herein are also applicable to generators.

An electric motor may include a rotor and a stator. The rotor includes permanent magnets and rotates relative to the stator. The rotor is connected to a rotor shaft that rotates with the rotor. The rotor is separated from the stator by an air gap. The stator includes conductors in the form of wire windings. When electrical current is passed through the wire windings, a magnetic field is generated having an associated magnetic flux. Power is transferred over the air gap as a result of the magnetic field acting on the permanent magnets of the rotor. As a result, electrical energy is converted to mechanical energy to rotate the rotor shaft. In an electric vehicle, the rotor is used to transfer torque via the rotating shaft through a gear set to drive wheels of the vehicle.

Two types of electric motors are radial flux motors and axial flux motors. In a radial flux motor, the rotor and stator are typically situated in a concentric or nested configuration, such that when the stator is energized, a magnetic flux is created that extends radially from the stator to the rotor. Conductive windings of the stator are typically arranged parallel to an axis of rotation such that a magnetic field is generated, which is oriented in a radial direction from the axis of rotation along the rotor shaft. In an axial flux motor, a magnetic field parallel to an axis of rotation is produced by the electrically conductive wire windings of the corresponding stator. Magnetic flux created in the axial flux motor extends parallel to an axis of rotation of the rotor shaft. Axial flux motors tend to be smaller, lighter, and generate more power than radial flux motors.

### SUMMARY

An axial flux motor is provided and includes a shaft, at least one rotor connected to the shaft, and a stator. The stator includes a stator core and an electrically conductive wire. The stator core is segmented and ring-shaped and includes a central opening through which the shaft extends to the at least one rotor. The stator core includes a hybrid segment. The hybrid segment includes soft magnetic composite material components and laminated layered blocks. The laminated layered blocks include two inclined laminated layered blocks, where a distance between the two inclined laminated layered blocks increases radially along a radially extending centerline of the hybrid segment. The electrically conductive wire wound on the hybrid segment.

In other features, the hybrid segment is a first hybrid segment. The stator core includes hybrid segments. The hybrid segments includes the first hybrid segment. Each of the hybrid segments includes soft magnetic composite material components and laminated layered blocks.

In other features, the laminated layered blocks of each of the hybrid segments include two inclined laminated layered blocks, where a distance between the two inclined laminated layered blocks of each of the hybrid segments increases radially along a respective radially extending centerline of the first hybrid segment.

In other features, the hybrid segment includes one or more non-inclined laminated layered blocks extending at least one of parallel to or radially along the radially extending centerline.

In other features, the one or more non-inclined laminated layered blocks includes a single non-inclined laminated layered block extending from a radially outermost edge of the hybrid segment radially inward along the radially extending centerline to the two inclined laminated layered blocks.

In other features, axial widths of layers of the two inclined laminated layered blocks are the same as axial widths of layers of the one or more non-inclined laminated layered block.

In other features, the hybrid segment includes non-inclined laminated layered blocks extending at least one of parallel to or radially along the radially extending centerline.

In other features, axial widths of layers of the two inclined laminated layered blocks are the same as axial widths of layers of the one or more non-inclined laminated layered blocks.

In other features, the non-inclined laminated layered blocks include: two non-inclined laminated layered blocks extend to a radially outermost edge of the hybrid segment; and a single non-inclined laminated layered block extending from the two non-inclined laminated layered blocks radially inward towards the two inclined laminated layered blocks.

In other features, axial widths of layers of the two inclined laminated layered blocks are the same.

In other features, an axial flux motor is provided and includes a shaft, at least one rotor and a stator. The at least one rotor is connected to the shaft. The stator includes a stator core and an electrically conductive wire. The stator core is segmented and ring-shaped and includes a central opening through which the shaft extends to the at least one rotor. The stator core includes a hybrid segment. The hybrid segment includes soft magnetic composite material components and a laminated layered insert including laminated layered blocks. A radially innermost one of the laminated layered blocks extends to a radially innermost edge of the hybrid segment. A radially outermost one of the laminated layered blocks extends to a radially outermost edge of the hybrid segment. An electrically conductive wire wound on the hybrid segment.

In other features, the hybrid segment is a first hybrid segment. The stator core includes hybrid segments. The hybrid segments include the first hybrid segment. Each of the hybrid segments includes soft magnetic composite material components and laminated layered blocks.

In other features, the hybrid segment includes one or more laminated layered blocks disposed between the radially innermost one of the laminated layered blocks and the radially outermost one of the laminated layered blocks.

In other features, the hybrid segment includes two laminated layered blocks disposed between the radially innermost one of the laminated layered blocks and the radially outermost one of the laminated layered blocks.

In other features, axial widths of laminated layers of one of the laminated layered blocks are the same.

In other features, axial widths of laminated layers of each of the laminated layered blocks are the same.

In other features, axial widths of the laminated layered blocks are different.

In other features, one or more of the laminated layered blocks extends axially to axial outermost edges of the hybrid segment.

In other features, the laminated layered blocks are arranged in a stepped configuration. The soft magnetic composite material components have stepped axially innermost surfaces matching dimensions of axially outermost surface dimensions of the laminated layered blocks.

In other features, an axial width of the radially innermost one of the laminated layered blocks is less than an axial width of a laminated layered block disposed between the radially innermost one of the laminated layered blocks and the radially outermost one of the laminated layered blocks. An axial width of the outermost one of the laminated layered blocks is larger than the axial width of a laminated layered block disposed between the radially innermost one of the laminated layered blocks and the radially outermost one of the laminated layered blocks.

Further areas of applicability of the present disclosure will become apparent from the detailed description, the claims and the drawings. The detailed description and specific examples are intended for purposes of illustration only and are not intended to limit the scope of the disclosure.

### BRIEF DESCRIPTION OF THE DRAWINGS

The present disclosure will become more fully understood from the detailed description and the accompanying drawings, wherein:

FIG. 1 is a perspective view of an example axial flux motor including a stator core and two rotors;

FIG. 2 is a perspective view of an example of a segmented stator core;

FIG. 3 is a perspective view of an example stator core segment having a soft magnetic composite (SMC) molded tooth and pole shoes;

FIG. 4 is a perspective view of an example stator core tooth including stacked laminated layers with varying widths;

FIG. 5 is a perspective view of an example stator core segment having a hybrid structure, where a tooth and pole shoes include SMC material and corresponding portions of laminated layered blocks;

FIG. 6 is a side view of an example of a stator core segment including inclined laminated layered blocks and a non-inclined laminated layered block in accordance with the present disclosure;

FIG. 7 is a side view of an example of a stator core segment including inclined laminated layered blocks and non-inclined laminated layered blocks in accordance with the present disclosure;

FIG. 8 is a side view of an example of a stator core segment including stacked laminated layered blocks having respective widths and extending collectively to radially inner and outer peripheral edges in accordance with the present disclosure;

FIG. 9 is an efficiency plot illustrating differences in efficiency between a first motor including stator core segments formed solely of SMC material and a second motor including hybrid stator core segments;

FIG. 10 is a top view of a portion of a vehicle including axial flux motors in accordance with the present disclosure; and

FIG. 11 a functional block diagram of a vehicle system including axial flux motors in accordance with the present disclosure.

In the drawings, reference numbers may be reused to identify similar and/or identical elements.

### DETAILED DESCRIPTION

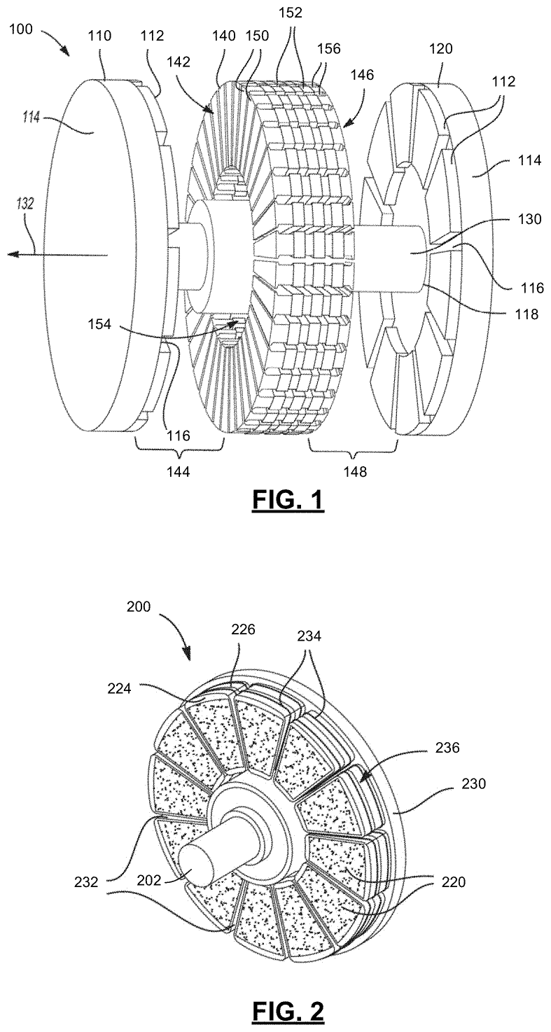

An example of an axial flux motor 100 is shown in FIG. 1. The axial flux motor 100 has a first rotor 110 and a second rotor 120 both connected to and configured to rotate about a rotor shaft 130. The examples disclosed herein are applicable to this style axial flux motor and other axial flux motors. For example, although two rotors are shown, an axial flux motor may include one or more rotors. Both the first and second rotors 110, 120 are annular-shaped with a centrally disposed aperture 118. The rotor shaft 130 passes through the centrally disposed aperture 118 and defines an axis-of-rotation 132 about which the rotors 110, 120 rotate. The axis-of-rotation 132 may extend along and/or include a longitudinal centerline of the rotor shaft 130.

A stator 140 is disposed axially between the rotors 110, 120 and is ring-shaped. The stator 140 is fixed and stationary, while the first and second rotors 110, 120 rotate during operation with the rotor shaft 130. The first rotor 110 faces a first side 142 of the stator 140 and defines a first air gap 144 therebetween. The second rotor 120 faces a second side 146 of the stator 140 and defines a second air gap 148 therebetween.

Although the axial flux motor 100 is shown to have a central single stator 140 and two external rotors 110, 120, the examples disclosed herein are also applicable to other configurations. Some example axial flux motor configurations include (i) two stators and a single rotor, or (ii) a single stator and two or more rotors. The axial motors may include respective housings and the corresponding rotors, stators and shafts may be disposed within the housings. The housings may be fixed to a vehicle frame and the shaft may be coupled to one or more axles, a gearbox (e.g., a reduction gearbox), another shaft, etc. of a corresponding vehicle.

Each of the rotors 110, 120 may have a same design and face in opposite directions towards the stator 140. Each of the rotors 110, 120 includes permanent magnets 112 affixed to a rotor body 114. The permanent magnets 112 may have alternating polarity. Each permanent magnet 112 defines a channel 116 therebetween, which may extend radially along a face of the respective rotor. In this manner, the permanent magnets 112 and the channel 116 can together define a plurality of magnetic poles.

The stator 140 includes a stator core including stator core segments (referred to herein as “segments”) 150 about which electrically conductive windings (or wound conductive wire) 152 are wrapped. The stator 140 defines slots 156 between adjacent ones of the stator core segments 150. The stator 140 may be fixed and stationary. The slots 156 may be configured to receive the electrically conductive windings 152, which may be wound in and through the slots 156. As an example, the windings 152 may include copper and/or copper alloys.

The rotor shaft 130 may pass through a centrally disposed aperture 154 in the stator 140 and be supported by bearings that align the rotors 110, 120 with respect to the stator 140 while allowing rotation of the rotor shaft 130. The electrically conductive windings 152 of the stator 140 may be formed of copper and/or other conductive materials. The electrically conductive windings 152 are configured to generate a magnetic field when current is applied to interact with magnetic fields of the permanent magnets 112. Different regions of the stator 140 may be selectively energized to impart a rotational force on the rotors 110, 120 causing the rotors 110, 120 and the rotor shaft 130 to rotate with respect to the axis-of-rotation 132.

The axial flux motor 100 provides a high-torque output and thus is applicable to high-torque applications, including for use in an electric or hybrid vehicle. In such a variation, a housing encasing the motor 100 may be attached to the vehicle frame and at least one output from an end of the rotor shaft 130 may be coupled to a reduction gearbox or directly to vehicle drive wheels.

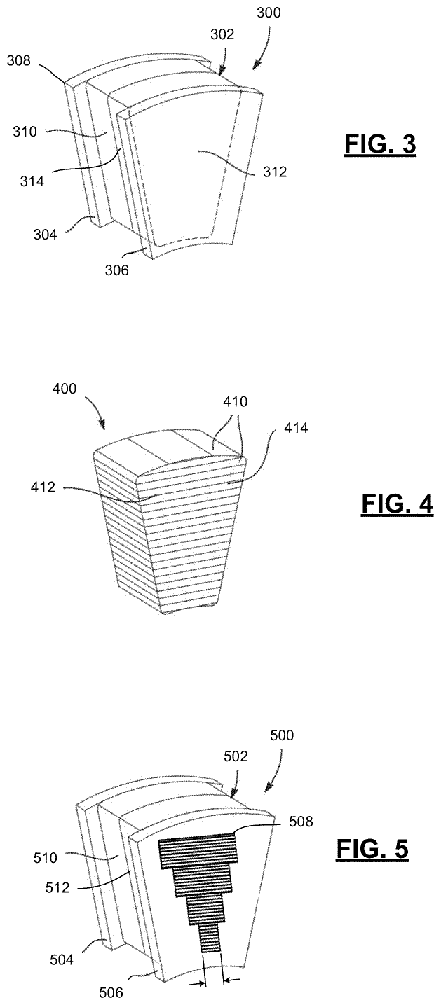

FIG. 2 shows an example of a segmented stator core 200 including segments 220 disposed on a stator disc 230. The segmented stator core 200 may replace the stator 140 of FIG. 1 and surrounds a rotor shaft 202. The segments 220 are generally trapezoidal shaped and formed at least partially of soft magnetic composite (SMC) material. One or more of the segments 220 may be configured as shown in FIGS. 3-5. In some embodiments, the segments 220 are each configured as shown in one or more of FIGS. 3-5. Gaps between the segments 220 are referred to as channels 232 and are defined by sides of the segments 220. As shown, the segments 220 may include recessed regions 226 that are configured to receive at least one electrically conductive wire that is wound around the segments 220 to provide windings 234. The wire may be wrapped about at least a portion of an exterior 236 of each of the segments 220. The SMC material can be readily manufactured into a variety of complex shapes to provide at least portions of the segments 220. The segments 220 may include pole shoes 224.

FIGS. 3-8 show stator core segments and portions thereof that may replace one or more of the segments 150, 220 of FIGS. 1-2. FIG. 3 shows an example stator core segment 300 having a SMC molded tooth 302 and pole shoes 304, 306. The stator core segment 300 may be formed as two components, for example, (i) a first component 308 including a first pole shoe 304 and a first axial portion 310 of the tooth 302, and (ii) a second component 312 including a second pole shoe 306 and a second axial portion 314 of the tooth 302. The first component 308 may be adhered to the second component 312. More specifically, the first axial portion 310 may be adhered to the second axial portion 314. The entire stator core segment may be formed of SMC or alternatively a first portion of the stator core segment 300 may be formed of SMC and another portion may be formed of and/or include laminated metal layers and/or one or more laminated layered blocks.

FIG. 4 shows an example stator core tooth 400 including stacked laminated layers 410 with varying widths. The laminated layers 410 of magnetic material may each include a ferromagnetic material, such as magnetic steel. The ferromagnetic material of each of the layers 410 may be isolated from each other by insulative coats. As an example, each of the layers 410 may include a magnetic material layer that is coated with an insulative and/or dielectric material. An insulative material is disposed between two adjacent magnetic material layers. The laminated layers 410 may be laminated steel sheets that are stacked, pressed, punched, annealed, and/or adhered to each other during a manufacturing process to form a laminated stator core tooth, as shown. When multiple laminated stator core teeth are assembled, the teeth provide magnetizable poles.

Each of the layers 410 of the tooth 400 has a respective and different set of dimensions, where each set includes a different length and width. Each of the layers 410 may have a same thickness. As an example, a first layer 412 has a first size defined by its length, width, and height (e.g., thickness), while a second layer 414 has a second size defined by its length, width, and height. The second size of the second layer 414 is smaller than the first size of the first layer 412. Due to the different sizes of each of the layers 400, manufacturing of the tooth 400 requires a significantly more complicated manufacturing process than a manufacturing process used to form the segment 300 of FIG. 3 and/or a tooth formed entirely of SMC material.

For an axial flux motor, it is easier to manufacture stator core segments using SMC material than it is to manufacture stator core segments using laminated layers. However, motor efficiency suffers because SMC exhibits higher cores loss than laminated magnetic steel layers. Torque capability is also lower for an axial flux motor including a stator core with SMC formed teeth as opposed to an axial flux motor including a stator core with laminated magnetic steel layered teeth.

FIG. 5 shows an example stator core segment 500 having a hybrid structure, where a tooth 502 and pole shoes 504, 506 include SMC and a laminated layered stack 508. The tooth 502 includes a first axial portion 510 and a second axial portion 512. The laminated layered stack 508 includes laminated layered blocks, where each laminated layered block includes a stack of laminated layers. Each laminated layer of a laminated layered block has the same or similar dimensions as each other laminated layer in the laminated layered block. In the example shown, each laminated layered block has a different width. An example width W is shown for one of the laminated layered blocks. By including the laminated layered stack 508, the segment 500 exhibits less loss and increased efficiency over the segment 300 of FIG. 3. As an example, the percentage of the total volume of the segment 500 that includes laminated layered blocks may be 45%.

The examples set forth herein include axial flux motors including stator cores with hybrid segments. The hybrid segments include both SMC material and laminated magnetic steel stacked layers, referred to as laminated layered blocks. Multiple hybrid examples are shown in FIGS. 6-8. The more laminated content of each segment, the less core loss and the better the operating efficiency of the motor. The hybrid examples are designed to maximize the amount of laminated content for a given envelope of a segment and as a result maximize operating efficiency

FIG. 6 shows an example of a stator core segment 600 including inclined laminated blocks 602, 604 and a non-inclined (or centerline extending) laminated block 606. The inclined laminated blocks 602, 604 are angled relative to a centerline 608. The centerline 608 extends radially and through a center of the segment 600. Each of the inclined laminated blocks 602, 604 extends to and thus shares an annular outer edge with an annular outer edge of the segment. For example, annular outer edge 610 of the inclined laminated block 602 is an annular outer edge of the segment 600. Similarly, an annular outer edge 612 of the inclined laminated block 604 is another annular outer edge of the segment 600. The non-inclined laminated block 606 extends along the centerline 608 and is centered in an annular direction on the centerline 608. The non-inclined laminated block 606 extends from a radially outer edge 620 of the segment 600 to inner annular edges 622, 624 of the inclined laminated blocks 602, 604.

Widths of each of the blocks 602, 604 and 606 may be the same. Lengths of each of the blocks 602, 604 may be the same and be longer than a length of the block 606. The widths are measured in an annular direction. The lengths are measured radially. As an example, a width W and a length L of the inclined laminated layered block 604 are shown. Depths of the blocks 602, 604 and 606 may also be the same. The depths are measured in an axial direction. The widths and depths of the blocks 602, 604 and 606 may be the same to reduce manufacturing complexity.

The segment 600 also includes SMC components 630, 632, 634. The SMC components 630, 632, 634 are triangular-shaped. The SMC component 630 is disposed between a radially inner edge 636 of the non-inclined laminated block 606 and the inner annular edges 622, 624. The SMC components 632, 634 are disposed between the inner annular edges 622, 624. The SMC components 632, 634 have radially outer edges 640, 642 that extend along the radially outer edge 620. Each of the SMC components 630, 632, 634 may be formed of SMC material and as described herein. The radially outer edge (or outer peripheral edge) 620 may be arc-shaped and/or have multiple linear edges, as shown. Each of the laminated layered blocks 602, 604, 606 extend to the linear edges. The laminated layered blocks 602, 604, 606 may have outer radial edges shaped to match the shape of corresponding portions of the radially outer edge 720.

SMC components referred to herein may be formed of SMC powders, the surface of which may be covered with an electrically insulating layer. The SMC powder may include an iron powder having fine particles that are able to be molded using a press to provide a predetermined shape. The particles may be coated with insulative material. Pressure from the press causes the particles to bind together. These powders are consolidated to form soft-magnetic components by means of pressing or consolidation. Thus, such an SMC material may be readily formed into a variety of different and complex shapes, like the substantially trapezoidal and triangular shapes shown in FIGS. 5-8.

The sizes and shapes of the segment 600, the blocks 602, 604, 606, and SMC components 630, 632, 634 may vary depending on the application. The sizes and shapes of the blocks 602, 604, 606 and SMC components 630, 632, 634 may be varied to maximize a ratio between a total volume of the blocks 602, 604, 606 and a total volume of the SMC components 630, 632, 634. As an example, the percentage of laminated layered material relative to a total volume of the segment 600 may be 76% or other percentage.

The segment 600 may not include pole shoes. In one embodiment, a stator core tooth is formed similar to the segment 600 and includes axially disposed pole shoes. The pole shoes may be partially formed of SMC material. The blocks 602, 604, 606 may extend axially into the pole shoes, similar to the example of FIG. 5. Although the segment 600 is shown including only two inclined laminated layered blocks and only one non-inclined laminated layered blocks, the segment 600 may include more inclined laminated layered blocks and/or more non-inclined laminated layered blocks.

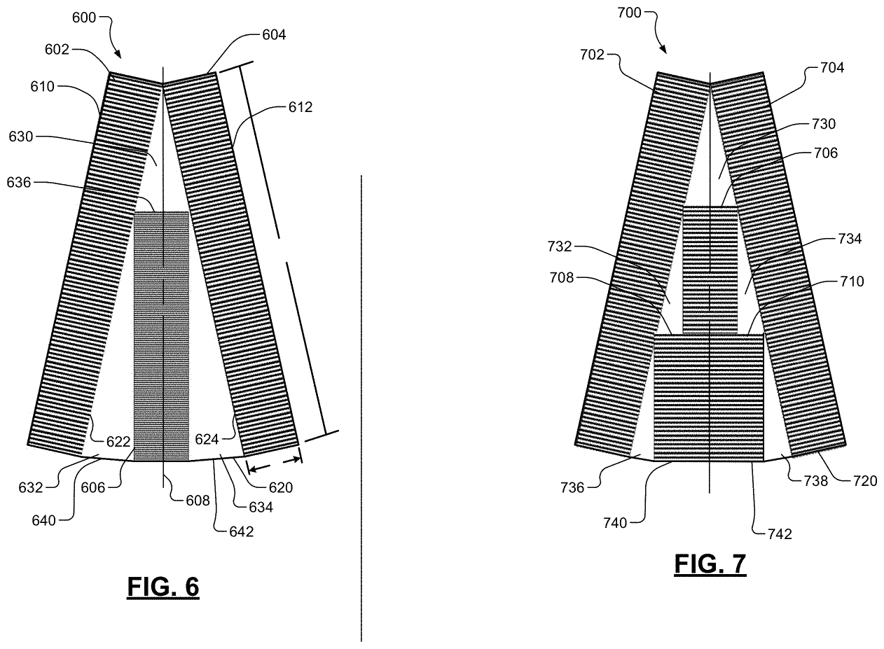

FIG. 7 shows an example of a stator core segment 700 that is similar to the stator core segment of FIG. 6, but instead of including a two inclined laminated layered blocks and a single non-inclined laminated layered block, the stator core segment 700 includes two inclined laminated layered blocks 702, 704 and multiple non-inclined laminated layered blocks 706, 708, 710. A centerline extends between the laminated layered blocks 708, 710 and through a center of the laminated layered block 706, which is disposed between and contacts the inclined laminated layered blocks 702, 704 and the non-inclined laminated layered blocks 708, 710. The laminated layered blocks 708, 710 are in contact with each other and respectively the laminated layered blocks 702, 704 and may be replaced with a single laminated layered block.

Widths of each of the blocks 702, 704, 706, 708 and 710 may be the same. Lengths of each of the blocks 702, 704 may be the same and longer than lengths of the blocks 706, 708 and 710. The lengths of the blocks 706, 708 and 710 may be the same. The depths of the 702, 704, 706, 708 and 710 may be the same. The widths are measured in an annular direction. The lengths are measured radially. The depths are measured in an axial direction. The widths and depths of the blocks 702, 704, 706, 708 and 710 may be the same to reduce manufacturing complexity.

Each of the laminated layered blocks 702, 704, 708, 710 extends to linear edges of a radially outer edge (or outer peripheral edge) 720 of the segment 700. The radially outer edge 720 may be arc-shaped. The laminated layered blocks 702, 704, 708, 710 may have outer radial edges shaped to match the shape of corresponding portions of the radially outer edge 720.

The segment 700 also includes SMC components 730, 732, 734, 736, 738. The SMC components 730, 732, 734, 736, 738 are triangular-shaped. The SMC component 730 is disposed between and adhered to the inclined laminated layered blocks 702, 704 and the non-inclined laminated layered block 706. The SMC components 732, 734 are disposed between and adhered to the inclined laminated layered blocks 702, 704 and the non-inclined laminated layered blocks 706, 708, 710. The SMC components 736, 738 are disposed between and adhered to the inclined laminated layered blocks 702, 704 and the non-inclined laminated layered blocks 708, 710. The SMC components 736, 738 have radially outer edges 740, 742 that extend along the radially outer edge 720. Each of the SMC components 730, 732, 734, 736, 738 may be formed of SMC material and as described herein. As an example, the percentage of laminated layered material relative to a total volume of the segment 700 may be 86% or other percentage.

The segment 700 may not include pole shoes. In one embodiment, a stator core tooth is formed similar to the segment 700 and includes axially disposed pole shoes. The pole shoes may be partially formed of SMC material. The blocks 702, 704, 706, 708, 710 may extend axially into the pole shoes, similar to the example of FIG. 5. Although the segment 700 is shown including only two inclined laminated layered blocks and only three non-inclined laminated layered blocks, the segment 700 may include more inclined laminated layered blocks and/or more non-inclined laminated layered blocks.

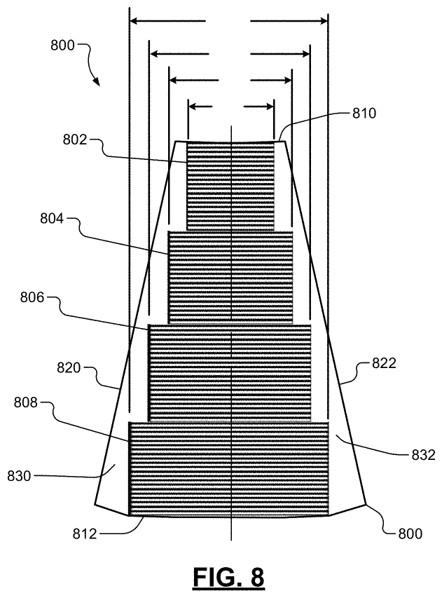

FIG. 8 shows an example of a stator core segment 800 including stacked laminated layered blocks 802, 804, 806, 808 having respective widths and extending collectively to radially inner and outer peripheral edges 810, 812. The laminated layered blocks 802, 804, 806, 808 are configured to provide a stepped structure as shown. The widths W1-W4 are shown respectively for the laminated blocks 802, 804, 806, 808. As shown, the width W1 of block 802 is smaller than the width W2 of block 804, which is smaller than the width of W3 of block 806. The width W4 of the block 808 is larger than the width W3. Although the blocks 802, 804, 806, 808 are shown having particular widths relative to annular outer inclined edges 820, 822 of the segment 800, the widths of the blocks 802, 804, 806, 808 may be smaller or larger than shown relative to distances between the inclined edges 820, 822. In one embodiment, the widths W1-W4 are increased, such that the laminated layered blocks extend to the inclined edges 820, 822.

The radially inner and outer peripheral edges 810, 812 may each be linear, arced and/or formed of linear edges, as shown. The radially inner edge of the laminated layered block 802 may match the shape of the radially inner peripheral edge 810. The radially outer edge of the laminated layered block 808 may match the shape of the radially outer peripheral edge 812. As an example, the percentage of laminated layered material relative to a total volume of the segment 800 may be 75% or other percentage.

The segment 800 includes two SMC components 830, 832. The SMC components 830, 832 include linear axially outermost edges and stepped axially innermost edges that match stepped axially outer dimensions of the laminated layered blocks 802, 804, 806, 808. The SMC components 830, 832 are adhered to the axially outer most surfaces of the laminated layered blocks 802, 804, 806, 808.

The segment 800 may not include pole shoes. In one embodiment, a stator core tooth is formed similar to the segment 800 and includes axially disposed pole shoes. The pole shoes may be partially formed of SMC material. The blocks 802, 804, 806, 808 may extend axially into the pole shoes, similar to the example of FIG. 5. Although the segment 800 is shown including four laminated layered blocks, the segment may include more or less laminated layered blocks.

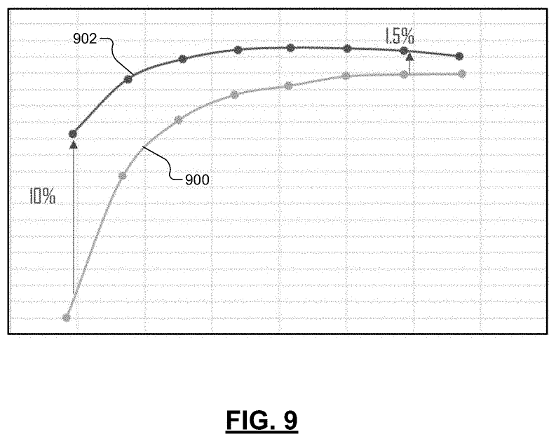

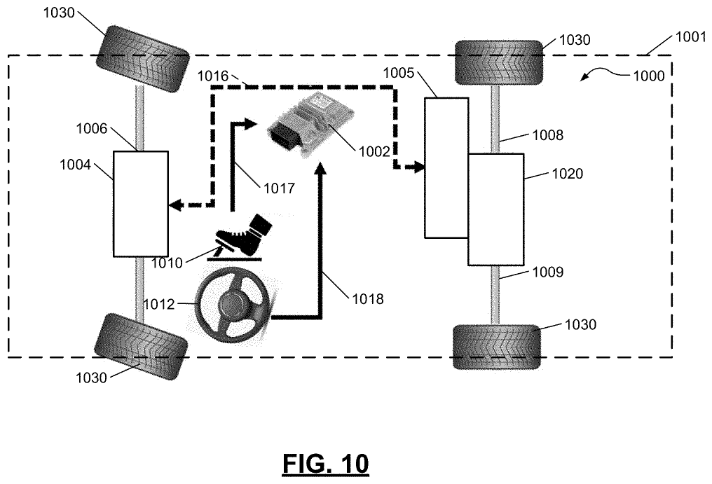

FIG. 9 shows an efficiency plot illustrating increased efficiency when using hybrid segments having increased laminated structural volume to overall structural volume ratios. The plot includes a first curve 900 and a second curve 902. The first curve 900 is an example efficiency curve for a first motor including a first stator core including segments formed with SMC material, where the segments do not include laminated layered blocks. An example of the first stator core is one formed with segments similar to that shown in FIG. 3. The second curve 902 is an example efficiency curve for a second motor including a second stator core including hybrid segments. The hybrid segments include both SMC material and laminated layered blocks. An example of the second stator core is one formed with segments similar to that shown in FIG. 5. Each of the efficiency curves 900, 902 relates efficiency percentages relative torque measured in, for example Newton-meters (Nm). The efficiency curves 900, 902 are for a particular motor speed (e.g., 3500 revolutions-per-minute (rpm)). The more efficiency the stator core, the higher the output torque for a same supplied voltage level and current level. Stator cores formed with segments, as shown in FIGS. 6-8, are more efficient than the stator cores shown in FIGS. 3 and 5.

The above-described examples include minimizing the number of different sided lamination layers in segments of a stator core. This is accomplished while maximizing the volumes of laminated layered blocks included in given overall volumes of the segments, which maximizes operating efficiency.

Each of the laminated layer blocks of FIGS. 6-8 include layers (or sheets). The sheets may include a ferromagnetic material and each may have at least one insulative layer or coating disposed therebetween. Suitable ferromagnetic materials for laminated stator core segments include magnetic steel. The insulating materials interleaved between adjacent layers may include non-magnetic materials. The insulating materials may include (i) a siloxane-based material, such as a silicone varnish, and/or (ii) a metal-organic and/or inorganic insulating material, which may include a silicate layer, an oxide layer, a phosphate layer, and equivalents and/or combinations thereof.

As shown, each sheet of each laminated layered block has substantially the same footprint as the other sheets of the same laminated layered blocks. For example, each sheet of each laminated layered block may have substantially the same dimensions including the same width, length, and thickness while accounting for manufacturing deviations and tolerances. The sheets may have rectangular shaped annular cross-sections. As an example, each sheet may have a thickness ranging from greater than or equal to 0.1 mm to less than or equal to about 0.5 mm. As an example, a total volume of the hybrid segment filled with laminated layered blocks may range from greater than or equal to about 10 volume % to less than or equal to about 90 volume %.

As an example, the laminated layered blocks of a segment may be formed in parallel with formation of the corresponding SMC components. The laminated layered blocks may then be adhered to the SMC components. As another example, the laminated layered blocks of a segment may be formed and arranged relative to each other and then the SMC components may be formed around to fill in gaps between the laminated layered blocks and areas within an outer envelope of the segment not filled with the laminated layered blocks.

Formation of each of the SMC components of FIGS. 6-8 may include use of one or more precursors of SMC material. The precursors may include for example, ferromagnetic powder particles and optional matrix materials, such as polymeric resin. The precursors may be introduced into a mold and fill regions between and/or around laminated layered blocks disposed therein. The precursors may be densified, for example, by applying compressive force to the mold. In certain aspects, the applied pressure may be greater than or equal to about 1,000 mega-Pascal (MPa). Additional heat and/or actinic radiation may be applied for reacting the matrix materials, for example, polymerizing or cross-linking. In certain variations, to enhance adhesion of the laminated insert to the molded SMC material, an adhesive or glue may be used at an interface therebetween.

The precursors may include particles defining a magnetic core surrounded by one or more insulating shell layers in a shell region. The magnetic material in the core may be ferromagnetic and include iron (e.g., iron or ferrite powder) or other magnetizable materials or alloys, including for example, iron alloys including silicon, nickel, and/or phosphorus. Other examples include rare earth metal compounds, such as those including samarium (Sm), neodymium (Nd), samarium cobalt (SmCo 1:5), samarium cobalt (SmCo 2:17), and neodymium iron boron (NdFeB). Other examples of suitable magnetic particles include aluminum nickel cobalt (AlNiCo) alloys. An average particle diameter of the magnetic particles may be greater than or equal to 50 micrometers to less than or equal to 250 micrometers. As an example the particle diameter may be 100 micrometers. The core region including the magnetic material may be surrounded by one or more insulation layers. The insulation layers may include a non-magnetic material, such as a siloxane-based material, a silicone varnish material, or a metal-organic or inorganic insulating material. The inorganic insulating material may include, for example a silicate layer, an oxide layer, a phosphate layer, and equivalents and combinations thereof. The insulating shell layers may have a total thickness of greater than or equal to 10 nanometers (nm) to less than or equal to about 1 millimeter (mm). As an example, the insulating shell layers may have a total thickness of greater than or equal to 10 nm to less than or equal to 800 micrometers.

Further, as necessary, a binder layer can serve as a matrix to help adhere individual particles to one another. The binder or matrix may include thermoset or thermoplastic polymers, such as elastomers or polytetrafluoroethylene, or alternatively, a wax, by way of example.

Relatively high pressing pressures are used to press and consolidate the precursor SMC powders to form the molded SMC material. While it is densified and compressed, it should be noted that the molded SMC material is not sintered.

In this manner, a molded SMC material may be integrally formed around a laminated insert including multiple laminated layered blocks, which is non-releasably seated within the molded SMC material. Thus, together the laminated insert and molded SMC material form a unitary single hybrid tooth and/or segment. It is advantageous to have the ability to mold ab exterior portion of the hybrid tooth and/or segment to form a complex shape, for example, as shown in FIGS. 5-8 (e.g., a substantially trapezoidal cross-sectional shape). As shown, the hybrid segment may define an external surface and include two pole shoes that together define annularly outer recessed regions. As noted above, the recessed regions are configured to receive wound wire conductors (or windings). The hybrid tooth and/or segment may have a variety of other shapes and configurations for receiving at least a portion of one or more wire windings. The hybrid teeth and segments of a stator core configured as disclosed herein may have complex shapes, while advantageously providing improved performance by reducing eddy currents and hysteresis due to the presence of integrated laminated core inserts.

While a vehicle example is described below, the present application is also applicable to non-vehicle implementations. The present application is applicable to other axial flux motor applications. It will be appreciated that the concepts apply not only to electric axial flux motors that generate mechanical energy from electrical energy, but also to axial flux generators that can generate electrical energy from mechanical energy.

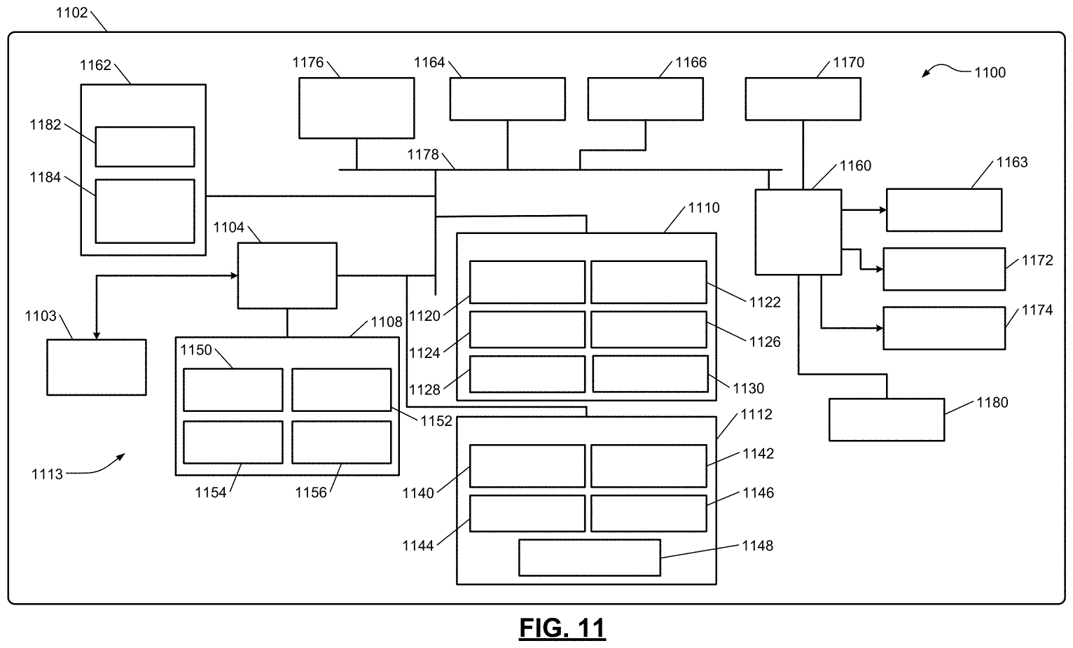

FIG. 10 shows a portion 1000 of a vehicle 1001 (referred to as a vehicle system) including axial flux motors 1004, 1005. The vehicle system includes a control module 1002, multiple axial flux motors 1004, 1005, a front axle 1006, a rear axles 1008, 1009, a user input device 1010, and a steering device (e.g., steering wheel) 1012. The control module 1002 controls distribution of output torque to the axles 1006, 1008 based on a torque requests. As an example, the torque requests may be provided by a driver via the user input device 1010 (e.g., an accelerator pedal) or via another input device, such as a steering angle (e.g., angle of a steering wheel). Distribution of output torque is represented by dashed line 1016 and inputs from the user input device 1010 and the steering device 1012 are represented by arrows 1017, 1018. The control module 1002 may implement the algorithms disclosed herein. In the example shown, the axial flux motor 1005 is connected to the rear axles 1008, 1009 via a differential transfer case 1020. The axles 1006, 1008, 1009 are connected to drive tires 1030.

FIG. 11 shows a vehicle system 1100 of a vehicle 1102 including one or more axial flux motors 1103. The vehicle system 1100 may operate similarly and/or be configured similarly as the vehicle system of FIG. 10. The vehicle system 1100 may include a chassis control module 1104 and torque sources, such as one or more axial flux motors 1103 and one or more engines (one engine 1108 is shown). The vehicle system 1100 may further include vehicle sensors 1110, and memory 1112. The chassis control module 1104 may control distribution of output torque to axles of the vehicle 1102 via the torque sources. The chassis control module 1104 may control operation of a propulsion system 1113 that includes the axial flux motors 1103 and the engine(s) 1108.

The sensors 1110 may include a steering sensor 1120 (e.g., a steering wheel sensor), a vehicle speed sensor 1122, accelerometers 1124, an accelerator pedal sensor 1126, a yaw rate sensor 1128 and other sensors 1130. The chassis control module 1104 controls the torque sources based on outputs of the sensors 1110.

The memory 1112 may store vehicle states 1140, tire forces 1142, driver inputs 1144, actuator constraints 1146, and other parameters and data 1148. The vehicle states 1140 may include longitudinal, lateral and vertical forces. The tire forces 1142 may indicate tire capacity levels. Driver inputs 1144 may refer to accelerator pedal positions, steering wheel angles, and/or other driver inputs. The actuator constraints 1146 may include maximum output torques of the torque sources (or how much output torque each torque source is capable of generating). The engine 1108 may include a starter motor 1150, a fuel system 1152, an ignition system 1154 and a throttle system 1156.

The vehicle 1102 may further include a body control module (BCM) 1160, a telematics module 1162, a brake system 1163, a navigation system 1164, an infotainment system 1166, an air-conditioning system 1170, other actuators 1172, other devices 1174, and other vehicle systems and modules 1176. The modules and systems 1104, 1160, 1162, 1164, 1166, 1170, 1176 may communicate with each other via a controller area network (CAN) bus 1178 and/or other suitable communication interface. A power source 1180 may be included and power the BCM 1160 and other systems, modules, devices and/or components. The power source 1180 may include one or more batteries and/or other power sources.

The telematics module 1162 may include transceivers 1182 and a telematics control module 1184. The BCM 1160 may control the modules and systems 1162, 1163, 1164, 1166, 1170, 1176 and other actuators, devices and systems (e.g., the actuators 1172 and the devices 1174). This control may be based on data from the sensors 1110.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules, circuit elements, semiconductor layers, etc.) are described using various terms, including “connected,” “engaged,” “coupled,” “adjacent,” “next to,” “on top of,” “above,” “below,” and “disposed.” Unless explicitly described as being “direct,” when a relationship between first and second elements is described in the above disclosure, that relationship can be a direct relationship where no other intervening elements are present between the first and second elements, but can also be an indirect relationship where one or more intervening elements are present (either spatially or functionally) between the first and second elements. As used herein, the phrase at least one of A, B, and C should be construed to mean a logical (A OR B OR C), using a non-exclusive logical OR, and should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A.

In this application, including the definitions below, the term “module” or the term “controller” may be replaced with the term “circuit.” The term “module” may refer to, be part of, or include: an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor circuit (shared, dedicated, or group) that executes code; a memory circuit (shared, dedicated, or group) that stores code executed by the processor circuit; other suitable hardware components that provide the described functionality; or a combination of some or all of the above, such as in a system-on-chip.

The module may include one or more interface circuits. In some examples, the interface circuits may include wired or wireless interfaces that are connected to a local area network (LAN), the Internet, a wide area network (WAN), or combinations thereof. The functionality of any given module of the present disclosure may be distributed among multiple modules that are connected via interface circuits. For example, multiple modules may allow load balancing. In a further example, a server (also known as remote, or cloud) module may accomplish some functionality on behalf of a client module.

The term code, as used above, may include software, firmware, and/or microcode, and may refer to programs, routines, functions, classes, data structures, and/or objects. The term shared processor circuit encompasses a single processor circuit that executes some or all code from multiple modules. The term group processor circuit encompasses a processor circuit that, in combination with additional processor circuits, executes some or all code from one or more modules. References to multiple processor circuits encompass multiple processor circuits on discrete dies, multiple processor circuits on a single die, multiple cores of a single processor circuit, multiple threads of a single processor circuit, or a combination of the above. The term shared memory circuit encompasses a single memory circuit that stores some or all code from multiple modules. The term group memory circuit encompasses a memory circuit that, in combination with additional memories, stores some or all code from one or more modules.

The term memory circuit is a subset of the term computer-readable medium. The term computer-readable medium, as used herein, does not encompass transitory electrical or electromagnetic signals propagating through a medium (such as on a carrier wave); the term computer-readable medium may therefore be considered tangible and non-transitory. Non-limiting examples of a non-transitory, tangible computer-readable medium are nonvolatile memory circuits (such as a flash memory circuit, an erasable programmable read-only memory circuit, or a mask read-only memory circuit), volatile memory circuits (such as a static random access memory circuit or a dynamic random access memory circuit), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general purpose computer to execute one or more particular functions embodied in computer programs. The functional blocks, flowchart components, and other elements described above serve as software specifications, which can be translated into the computer programs by the routine work of a skilled technician or programmer.

The computer programs include processor-executable instructions that are stored on at least one non-transitory, tangible computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation) (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective-C, Swift, Haskell, Go, SQL, R, Lisp, Java®, Fortran, Perl, Pascal, Curl, OCaml, Javascript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

What is claimed is:

1. An axial flux motor comprising:
a shaft;
at least one rotor connected to the shaft; and
a stator comprising
a stator core, wherein
the stator core is segmented and ring-shaped and includes a central opening through which the shaft extends to the at least one rotor,
the stator core comprises a hybrid segment,
the hybrid segment comprises a plurality of soft magnetic composite material components and a plurality of laminated layered blocks, and
the plurality of laminated layered blocks include two inclined laminated layered blocks, where a distance between the two inclined laminated layered blocks increases radially along a radially extending centerline of the hybrid segment, and
an electrically conductive wire wound on the hybrid segment.

2. The axial flux motor of claim 1, wherein:
the hybrid segment is a first hybrid segment;
the stator core includes a plurality of hybrid segments;
the plurality of hybrid segments includes the first hybrid segment; and
each of the plurality of hybrid segments comprises a plurality of soft magnetic composite material components and a plurality of laminated layered blocks.

3. The axial flux motor of claim 2, wherein the plurality of laminated layered blocks of each of the plurality of hybrid segments include two inclined laminated layered blocks, where a distance between the two inclined laminated layered blocks of each of the plurality of hybrid segments increases radially along a respective radially extending centerline of the first hybrid segment.

4. The axial flux motor of claim 1, wherein the hybrid segment includes one or more non-inclined laminated layered blocks extending at least one of parallel to or radially along the radially extending centerline.

5. The axial flux motor of claim 4, wherein the one or more non-inclined laminated layered blocks includes a single non-inclined laminated layered block extending from a radially outermost edge of the hybrid segment radially inward along the radially extending centerline to the two inclined laminated layered blocks.

6. The axial flux motor of claim 4, wherein axial widths of layers of the two inclined laminated layered blocks are the same as axial widths of layers of the one or more non-inclined laminated layered block.

7. The axial flux motor of claim 1, wherein the hybrid segment includes a plurality of non-inclined laminated layered blocks extending at least one of parallel to or radially along the radially extending centerline.

8. The axial flux motor of claim 7, wherein axial widths of layers of the two inclined laminated layered blocks are the same as axial widths of layers of the one or more non-inclined laminated layered blocks.

9. The axial flux motor of claim 7, wherein the plurality of non-inclined laminated layered blocks comprise:
two non-inclined laminated layered blocks extend to a radially outermost edge of the hybrid segment; and
a single non-inclined laminated layered block extending from the two non-inclined laminated layered blocks radially inward towards the two inclined laminated layered blocks.

10. The axial flux motor of claim 1, wherein axial widths of layers of the two inclined laminated layered blocks are the same.

11. An axial flux motor comprising:
a shaft;
at least one rotor connected to the shaft; and
a stator comprising
a stator core, wherein
the stator core is segmented and ring-shaped and includes a central opening through which the shaft extends to the at least one rotor,
the stator core comprises a hybrid segment,
the hybrid segment comprises a plurality of soft magnetic composite material components and a laminated layered insert including a plurality of laminated layered blocks,
a radially innermost one of the plurality of laminated layered blocks extends to a radially innermost edge of the hybrid segment, and
a radially outermost one of the plurality of laminated layered blocks extends to a radially outermost edge of the hybrid segment, and
an electrically conductive wire wound on the hybrid segment.

12. The axial flux motor of claim 11, wherein:
the hybrid segment is a first hybrid segment;
the stator core comprises a plurality of hybrid segments;
the plurality of hybrid segments include the first hybrid segment; and
each of the plurality of hybrid segments comprises a plurality of soft magnetic composite material components and a plurality of laminated layered blocks.

13. The axial flux motor of claim 11, wherein the hybrid segment comprises one or more laminated layered blocks disposed between the radially innermost one of the plurality of laminated layered blocks and the radially outermost one of the plurality of laminated layered blocks.

14. The axial flux motor of claim 11, wherein the hybrid segment comprises two laminated layered blocks disposed between the radially innermost one of the plurality of laminated layered blocks and the radially outermost one of the plurality of laminated layered blocks.

15. The axial flux motor of claim 11, wherein axial widths of laminated layers of one of the plurality of laminated layered blocks are the same.

16. The axial flux motor of claim 11, wherein axial widths of laminated layers of each of the plurality of laminated layered blocks are the same.

17. The axial flux motor of claim 11, wherein axial widths of the plurality of laminated layered blocks are different.

18. The axial flux motor of claim 11, wherein one or more of the plurality of laminated layered blocks extends axially to axial outermost edges of the hybrid segment.

19. The axial flux motor of claim 11, wherein:
the plurality of laminated layered blocks are arranged in a stepped configuration; and
the plurality of soft magnetic composite material components have stepped axially innermost surfaces matching dimensions of axially outermost surface dimensions of the plurality of laminated layered blocks.

20. The axial flux motor of claim 11, wherein:
an axial width of the radially innermost one of the plurality of laminated layered blocks is less than an axial width of a laminated layered block disposed between the radially innermost one of the plurality of laminated layered blocks and the radially outermost one of the plurality of laminated layered blocks; and
an axial width of the outermost one of the plurality of laminated layered blocks is larger than the axial width of a laminated layered block disposed between the radially innermost one of the plurality of laminated layered blocks and the radially outermost one of the plurality of laminated layered blocks.
